(19) United States
(12) Patent Application Publication
(10) Pub. No.: US 2016/0076811 A1
(43) Pub. Date: Mar. 17, 2016

(54) DROPLET REMOVAL APPARATUS FOR OPTICAL FILM

(71) Applicant: NITTO DENKO CORPORATION, Osaka (JP)

(72) Inventors: Masayoshi KASAI, Osaka (JP); Daichi UESHIKI, Osaka (JP); Teppei OKUMURA, Osaka (JP)

(21) Appl. No.: 14/784,156

(22) PCT Filed: Mar. 9, 2015
(86) PCT No.: PCT/JP2015/056797

§ 371 Date: Oct. 13, 2015

(30) Foreign Application Priority Data
Mar. 7, 2014 (CN) 201410081844.3

(51) Int. Cl. F26B 13/28

(52) U.S. Cl. CPC F26B 13/28

(57) ABSTRACT

A droplet removal apparatus comprises a first liquid-scraping unit and a second liquid-scraping unit which are displaced from each other in an up-down direction along a movement direction of the optical film and arranged, respectively, on right and left sides across the optical film. Each of the first and second liquid-scraping units comprises a liquid-scraping member for scraping off the droplets, and a liquid-scraping member holding mechanism comprising a pressing-side holding member, a support-side holding member having a pair of angle adjustment shafts provided, respectively, at longitudinally opposite ends thereof to protrude outwardly. The pressing-side holding member and the support-side holding member are detachably fastened together in such a manner as to cooperatively hold the liquid-scraping member.

### TECHNICAL FIELD

The present invention relates to an optical film, and more particularly to a droplet removal apparatus for an optical film.

### BACKGROUND ART

In timepieces, mobile phones, PDAs, notebook computers, monitors for personal computers, DVD players, TVs and others, a liquid crystal display is being rapidly deployed in markets. The liquid crystal display is a device capable of visualizing a change in polarization state caused by liquid crystal switching. From its display principle, a polarizing film is used as an optical film.

Particularly, in the field of TVs and the like, there is an increasing need for higher brightness, higher contrast and wider viewing angle. Therefore, the polarizing film increasingly requires higher transmittance, higher polarization degree, higher color reproducibility and others. Generally, the polarizing film is configured by bonding two transparent protective films to opposite surfaces of a polarizer, respectively, wherein the bonding is performed using a so-called “water-based adhesive” prepared by dissolving a polyvinyl alcohol-based material in water.

The term “polarizer” means an optical film having a function of transmitting a specific linearly polarized light component extracted from polarized light components or natural light. The polarizer is produced by subjecting a polyvinyl alcohol (hereinafter abbreviated as simply as “PVA”)-based resin film to stretching and iodine adsorption. For this purpose, a wet stretching system is generally employed which is configured to allow the PVA-based resin film to pass through a plurality of baths and then undergo a drying step.

As such a wet stretching system, there is a technique disclosed in the following Patent Document 1, wherein a raw material film 11, such as a PVA-based resin film, unrolled from a roll 10 is subjected to a wet stretching step while it is passed through a swelling both 13, a dyeing bath 14 and a boric acid bath 15 by being guided by a series of guide rollers 12, and the PVA-based resin film 11 which has undergone the above wet stretching step is subjected to a next step, i.e., a washing step which is carried out in a water-washing bath 16, in which the PVA-based resin film is passed through a washing bath storing therein washing liquid such as water to wash away an unwanted residue such as boric acid adhering to the film in the preceding step, as illustrated in FIG. 1. The PVA-based resin film which has undergone the washing step is passed through a drying chamber 18 to perform a drying step. For example, the drying step is performed in such a manner that the PVA-based resin film washed in the washing step is introduced into the drying chamber 18 and appropriately dried through an optimal method, e.g., natural drying, drying by air-blowing, or drying by heating. In this way, the polarizer is produced.

However, in the production process based on the steps described in the Patent Document 1, it is often the case that liquid droplets remain on the PVA-based resin film which has exited the washing bath. If the PVA-based resin film in this state is passed through the drying step to have the liquid droplets on the film vaporized, water marks may be formed on the film and/or foreign substances may be left on the film as residue after vaporization, causing a negative influence on optical properties of the produced polarizer, and others.

Therefore, it has been desired to provide an apparatus for removing droplets before entering the drying chamber from the washing bath.

The following Patent Document 2 discloses a PVA-based resin film processing apparatus as illustrated in FIG. 2 and comprising a washing bath I, a dyeing bath II, and a film-hardening bath III, wherein there is disclosed an arrangement in which a droplet removal apparatus IV comprised of a liquid-scraping blade pair and a liquid-scraping roller pair is provided to scrape off liquid on a PVA-based resin film, and wherein the droplet removal apparatus IV is installed for each of the three baths I, II, III, and configured to scrape off droplets of liquid from a corresponding one of the baths and return the scraped droplets to the corresponding bath located therebeneath.

### CITATION LIST

### Patent Document

Patent Document 1: JP 2012-003173A

Patent Document 2: JP 2004-109698A

### SUMMARY OF INVENTION

### Technical Problem

However, the inventors found that the droplet removal apparatus disclosed in the Patent Document 2 have the following problems. The droplet removal apparatus is designed to be installed for each of the three baths, thereby causing inconvenience in terms of installation and maintenance, and an increase in cost. Moreover, the droplet removal apparatus (e.g., liquid-scraping blade) is incapable of being adjusted depending on a type, movement speed or thickness of the polarizer.

In addition to the Patent Document 2, there are some documents disclosing a droplet removal apparatus using an air knife or a nip roll. However, any configuration described in the prior art documents have a disadvantage of being unable to reduce a boric acid deposit adhering to a surface of the polarizer, i.e., fully achieve intended droplet removal.

Therefore, in view of the above circumstances, the present invention addresses a technical problem of providing a droplet removal apparatus for an optical film, capable of substantially fully eliminating water marks and/or vaporization residue just before a drying step, and adjusting an angle of a liquid-scraping blade depending on a type, movement speed, thickness, etc., of an optical film such as a polarizer, while ensuring wide applicability, high maintainability and stability of optical properties of the optical film.

### Solution to Technical Problem

According to one aspect of the present invention, there is provided a droplet removal apparatus which is disposed between a final bath and a drying chamber in a production process of an optical film to remove droplets adhering to the optical film.

The droplet removal apparatus comprises a first liquid-scraping unit and a second liquid-scraping unit which are displaced from each other in an up-down direction along a movement direction of the optical film and arranged, respectively, on opposite sides across the optical film. Each of the first and second liquid-scraping units comprises: a liquid-scraping member for scraping off the droplets; a liquid-scraping member holding mechanism comprising a pressing-side holding member, and a support-side holding member having a pair of angle adjustment shafts provided, respectively, at longitudinally opposite ends thereof to protrude outwardly, wherein the pressing-side holding member and the support-side holding member are detachably fastened together in such a manner as to cooperatively hold the liquid-scraping member; and a pair of angle adjustment mechanisms provided, respectively, on longitudinally opposite sides of the liquid-scraping member holding mechanism, wherein each of the angle adjustment mechanisms comprises a locking block at least formed with an angle adjustment shaft-receiving space for receiving therein a corresponding one of the angle adjustment shafts. Each of the angle adjustment mechanisms is configured to adjust and lock the liquid-scraping member holding mechanism in such a manner as to allow an angle of the liquid-scraping member with respect to the optical film to be set to a given value.

Preferably, the first and second liquid-scraping units are fixedly installed at respective positions across the optical film and each away from the optical film by a given first distance.

Preferably, each of the first and second liquid-scraping units further comprises: a guide member provided at a bottom of each of the angle adjustment mechanisms; a moving device connected to the guide member; and a guide rail configured to guide the guide member in forward and backward directions and having a guide stopper at a distal end thereof, wherein the first and second liquid-scraping units are movably installed at respective positions across the optical film and each away from the optical film by a given second distance.

Preferably, one of the first and second liquid-scraping units is fixedly installed at a position on one of the opposite sides of the optical film and away from the optical film by a given first distance, and the remaining one of the first and second liquid-scraping units is movably installed at a position on the other side of the optical film and away from the optical film by a given second distance, wherein the movable one of the first and second liquid-scraping units further comprises: a guide member provided at a bottom of each of the angle adjustment mechanisms; a moving device connected to the guide member; and a guide rail configured to guide the guide member in forward and backward directions and having a guide stopper at a distal end thereof.

Preferably, the pressing-side holding member is formed with a through-hole for inserting a first locking device for detachably fastening the pressing-side holding member and the support-side holding member together, and the support-side holding member is formed with a threaded hole for receiving the first locking device to be threadingly engaged therewith to thereby establish the retention of the liquid-scraping member.

Preferably, each of the pressing-side holding member and the support-side holding member is formed with a through-hole for allowing a first locking device for detachably fastening the pressing-side holding member and the support-side holding member together to be penetratingly inserted thereinto, wherein the pressing-side holding member and the support-side holding member are fastened together by penetratingly inserting the first locking device into the respective through-holes thereof and fixing the first locking device by a second locking device.

Preferably, each of the angle adjustment mechanisms further comprises a support block for supporting the locking block, wherein the angle adjustment shaft-receiving space is defined by two recesses formed in respective central regions of opposed surfaces of the locking block and the support block, and wherein the support block has a pair of threaded holes formed at respective positions across the recess thereof and each configured to allow a third locking device to be threadingly engaged therewith, and the locking block has a pair of through-holes formed at respective positions across the recess thereof and each configured to allow the third locking device to be penetratingly inserted thereinto.

Preferably, each of the angle adjustment mechanisms further comprises a support block for supporting the locking block, wherein: the locking block has an approximately semicircular-shaped boss formed on a surface thereof on a side opposite to a contact surface thereof with the support block to protrude in a direction away from the support block; the angle adjustment shaft-receiving space is formed in a central region of the boss; and the boss has a threaded hole formed at a center of an outer peripheral wall thereof in its circumferential and thickness directions to extend along a support direction of the support block and configured to allow a fourth locking device to be threadingly driven thereinto, and wherein the locking block has a pair of through-holes formed at respective positions across the boss thereof and each configured to allow a third locking device to be penetratingly inserted thereinto, and the support block has a pair of threaded holes formed correspondingly to the through-holes of the locking block.

Preferably, each of the angle adjustment mechanisms further comprises a support block for supporting the locking block, wherein the locking block has an approximately semicircular-shaped boss formed on a surface thereof on a side opposite to a contact surface thereof with the support block to protrude in a direction away from the support block, and the angle adjustment shaft-receiving space for receiving therein a corresponding one of the angle adjustment shafts is formed in a central region of the boss, and wherein: each of the angle adjustment shafts is partially formed into a taper shape in which a shaft diameter thereof gradually decreases in a direction from a position spaced apart from a corresponding one of opposite lateral surfaces of the liquid-scraping member holding mechanism by a given distance toward a corresponding one of the angle adjustment mechanisms; the angle adjustment shaft-receiving space is formed into a taper shape to receive therein the taper-shaped portion of the corresponding angle adjustment shaft; and the angle adjustment shaft is formed along its longitudinal axis with a threaded hole for receiving a fourth locking device in a thread engagement therewith to thereby lock the angle adjustment shaft, wherein an axial length of the taper-shaped portion of the angle adjustment shaft is less than a thickness of the boss, and wherein the locking block has a pair of through-holes formed at respective positions across the boss thereof and each configured to allow a third locking device to be penetratingly inserted thereinto, and the support block has a pair of threaded holes formed correspondingly to the through-holes of the locking block.

Preferably, the locking block has an approximately semicircular-shaped boss protrudingly formed on an upper surface thereof; the angle adjustment shaft-receiving space is formed in a central region of the boss; and the boss has a threaded hole formed at a center of an outer peripheral wall thereof in its circumferential and thickness directions to extend in a direction along which the locking block stands and configured to allow a fourth locking device to be threadingly driven thereinto.

Preferably, the locking block has an approximately semicircular-shaped boss protrudingly formed on an upper surface thereof, and the angle adjustment shaft-receiving space for receiving therein a corresponding one of the angle adjustment shafts is formed in a central region of the boss, wherein: each of the angle adjustment shafts is partially formed into a taper shape in which a shaft diameter thereof gradually decreases in a direction from a position spaced apart from a corresponding one of opposite lateral surfaces of the liquid-scraping member holding mechanism by a given distance toward a corresponding one of the angle adjustment mechanisms; the angle adjustment shaft-receiving space is formed into a taper shape to receive therein the taper-shaped portion of the corresponding angle adjustment shaft; and the angle adjustment shaft is formed along its longitudinal axis with a threaded hole for receiving a fourth locking device in a thread engagement therewith to thereby lock the angle adjustment shaft, wherein an axial length of the taper-shaped portion of the angle adjustment shaft is less than a thickness of the boss.

Preferably, an offset distance between the first and second liquid-scraping units in the up-down direction is 20 to 30 mm.

Preferably, a depressed distance of the optical film by the liquid-scraping member is 5 to 15 mm.

Preferably, the respective liquid-scraping members of the first and second liquid-scraping units are disposed in opposed relation to each other in such a manner that an angle of the liquid-scraping member of the first liquid-scraping unit with respect to the optical film becomes different from an angle of the liquid-scraping member of the second liquid-scraping unit with respect to the optical film.

Preferably, the liquid-scraping member has a length greater than a width of the optical film.

Preferably, corners of one side of the liquid-scraping member to be brought into contact with the optical film are subjected to rounding or chamfering.

Preferably, opposite surfaces of the liquid-scraping member are subjected to mirror-like finishing.

Preferably, the liquid-scraping member is formed of one or more selected from the group consisting of: abrasion-resistant stainless steel, abrasion-resistant coated iron, abrasion-resistant resin materials, and abrasion-resistant ceramic materials.

Preferably, the liquid-scraping member has a thickness of 1 to 10 mm.

Preferably, the pressing-side holding member and/or the support-side holding member of the liquid-scraping member holding mechanism are formed to define a liquid-scraping member-receiving space for holding the liquid-scraping member.

Preferably, the moving device is composed of one selected from the group consisting of an air cylinder, a ball screw, a handle and a combination of two or more thereof.

Preferably, the droplet removal apparatus comprises a laser sensor or a proximity sensor as a substitute for the guide stopper.

Preferably, each of the angle adjustment mechanisms further comprises an angular sensor.

### Effect of Invention

According to the present invention, there is provided a droplet removal apparatus for an optical film, which is capable of fully removing liquid droplets on the optical film just before a drying step to thereby prevent occurrence of water marks and/or vaporization residue on the optical film to ensure optical properties of the optical film, while also ensuring wide applicability and high maintainability.

### BRIEF DESCRIPTION OF DRAWINGS

FIG. 1 is a schematic diagram illustrating a conventional polarizer production process.

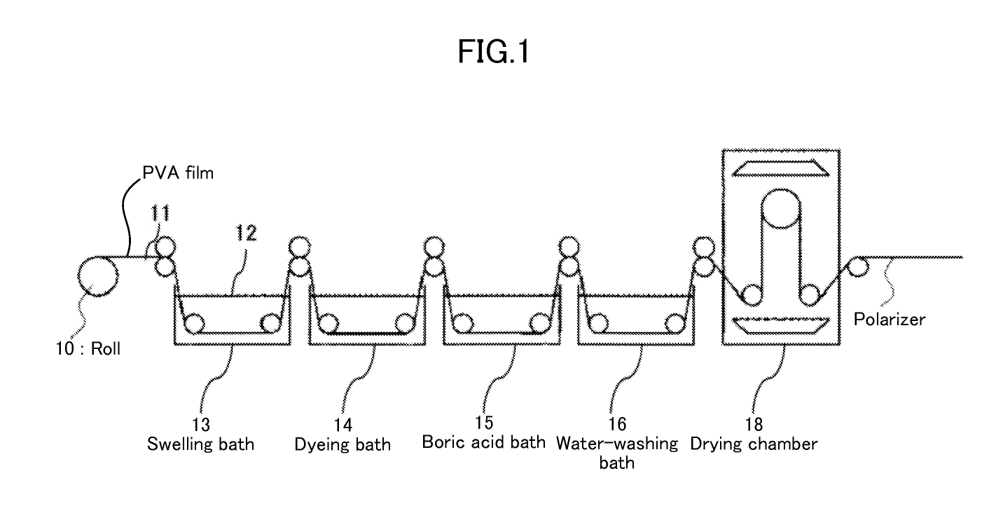

FIG. 2 is a schematic diagram illustrating a conventional droplet removal apparatus for a polarizer.

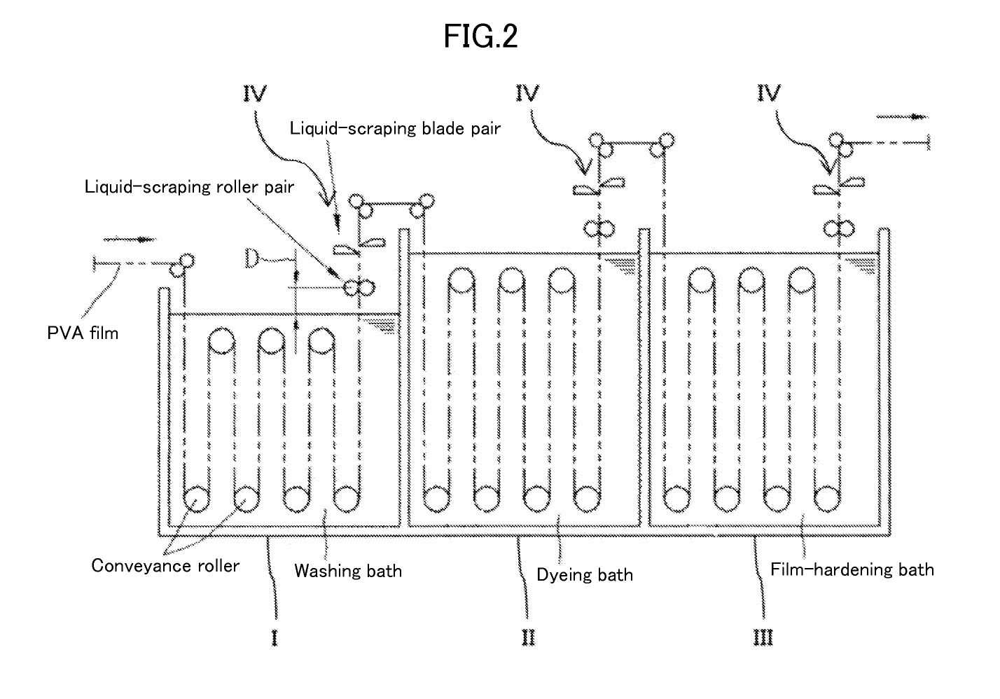

FIG. 3(a) is a schematic diagram illustrating a part of a polarizer production process incorporating a droplet removal apparatus according to the present invention, and FIG. 3(b) and FIG. 3(c) are, respectively, a schematic diagram illustrating one example where the droplet removal apparatus is disposed just above a final bath, and another example where the droplet removal apparatus is disposed offset from the final bath.

FIG. 4 (a) is a schematic diagram enlargedly illustrating an installation position in FIG. 3, and FIG. 4(b) is a detailed diagram corresponding to FIG. 4 (a).

FIG. 5(a) is a schematic diagram illustrating a state when droplets adhering to a polarizer are scraped by the droplet removal apparatus, and FIG. 5(b) and FIG. 5(c) are, respectively, a schematic diagram illustrating a structure of the droplet removal apparatus, and a schematic diagram illustrating a movement of a liquid-scraping blade.

FIGS. 6(a) to 6(c) are schematic diagrams illustrating a structure of the liquid-scraping blade.

FIGS. 7(a) to 7(d) are schematic diagrams illustrating a structure of a liquid-scraping blade holder.

FIG. 8(a) is a schematic diagram illustrating one example of a fastening scheme, and FIG. 8(b) is a schematic diagram illustrating another example of the fastening scheme.

FIG. 9(a) is a schematic diagram illustrating a state in which an angle adjustment shaft is locked to an angle adjusting frame, FIG. 9(b) is an exploded diagram of the angle adjusting frame as seen from right side of FIG. 9(a), and FIG. 9(c) is a side view illustrating the holder and the blade with the angle adjustment shaft locked to the angle adjusting frame.

FIG. 10 is a schematic diagram illustrating one modification of the structure illustrated in FIG. 9.

FIG. 11 is a schematic diagram illustrating one modification of the structure illustrated in FIG. 10.

FIG. 12 is a schematic diagram illustrating transition from a standby state to an active state in a first example of installation of the droplet removal apparatus.

FIG. 13 is a schematic diagram illustrating transition from a standby state to an active state in a second example of installation of the droplet removal apparatus.

FIG. 14 is a schematic diagram illustrating transition from a standby state to an active state in a third example of installation of the droplet removal apparatus.

FIG. 15 is a schematic diagram illustrating a depressed distance of a polarizer by the liquid-scraping blade.

FIG. 16 is a schematic diagram illustrating an example where the droplet removal apparatus according to the present invention is applied to a production process of an optical film other than a polarizer.

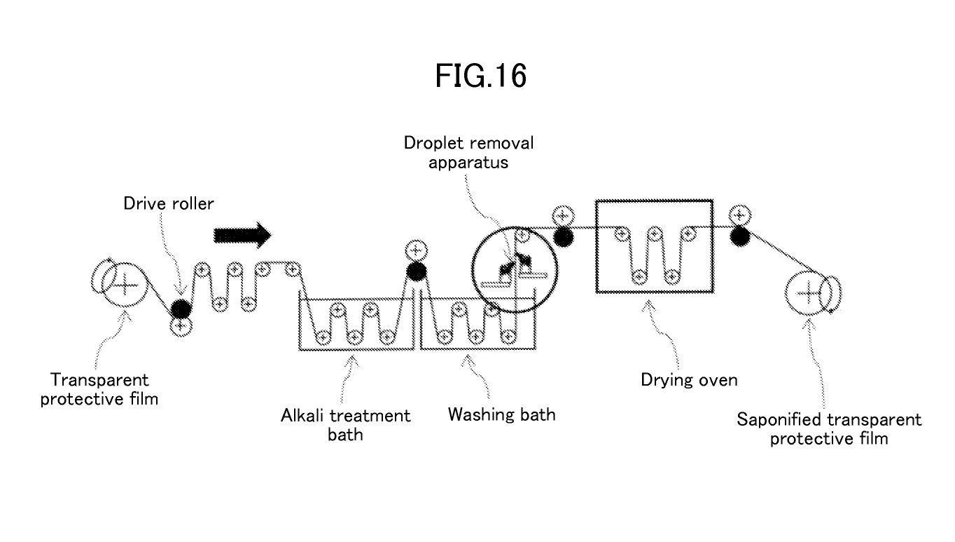

### DESCRIPTION OF EMBODIMENTS

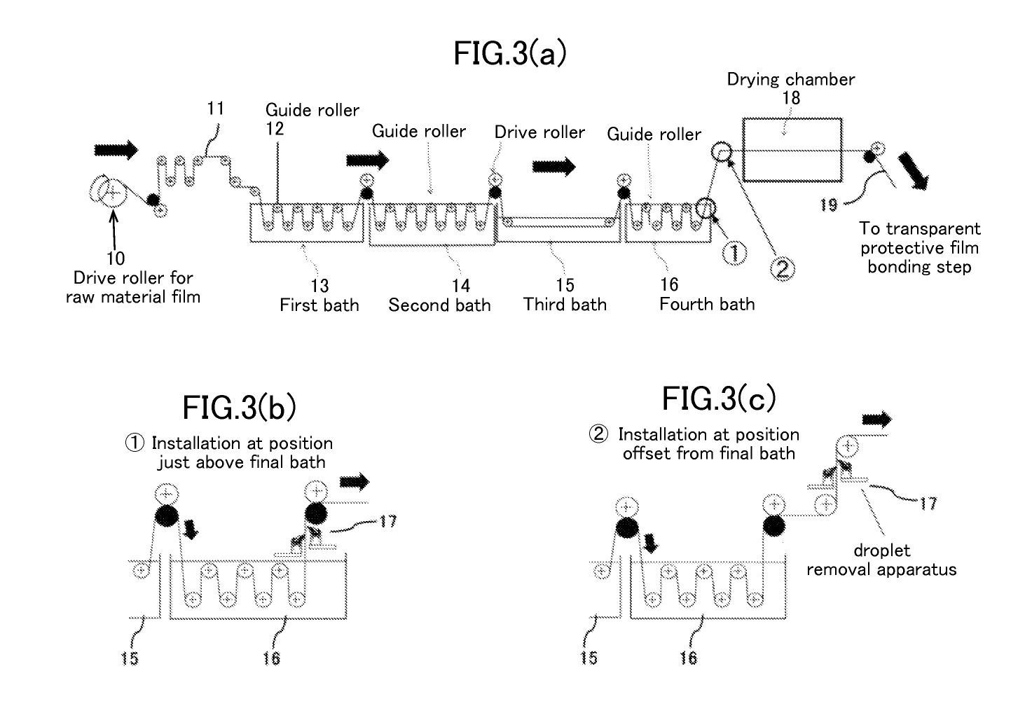

With reference to FIGS. 3 to 13, the present invention will now be described in detail. The figures are shown by way of examples only for illustrating the present invention in a comprehensible way, but not intended to limit the present invention. Therefore, it is apparent to those skilled in the art that an actual size, quantity, structure and others are not limited to those illustrated in the figures.

FIG. 3(a) is a schematic diagram illustrating a polarizer production process. In this production process, a swelling bath 13 for performing a swelling treatment (hereinafter referred to as “first bath”), a dyeing bath 14 for performing a dyeing treatment (hereinafter referred to as “second bath”) and a boric acid bath 15 for performing a boric acid treatment (hereinafter referred to as “third bath”) are arranged in this order to allow a raw material film 11 (e.g., PVA-based resin film) fed from a drive roller 10 to sequentially pass therethrough under guidance of a plurality of guide rollers 12, as illustrated in FIG. 3(a). Generally, the raw material film 11 which is already transformed into a polarizer is passed after exiting the boric acid bath 15 through a water-washing bath 16 (fourth bath) to wash off an un-reacted aqueous boric acid solution adhering thereto in the fourth bath, and then moved toward a drying chamber 18 while scraping off droplets adhering to the polarizer by a droplet removal apparatus 17 illustrated in FIG. 3, whereafter it is dried while being passed through the drying chamber to obtain a finished polarizer. Generally, in a subsequent process, a transparent protective film is bonded to at least one of opposite surfaces of the obtained polarizer to form a polarizing film, although illustration is omitted.

As above, the polarizer production process comprises the following steps (1) to (7).

(1) A swelling treatment step of passing a PVA-based resin film through a swelling bath of a swelling liquid consisting primarily of water to immerse the PVA-based resin film in the swelling liquid, causing swelling of the PVA-based resin film.
(2) A dyeing treatment step of passing the swelled PVA-based resin film through a dyeing bath of a dyeing solution containing a dichroic dye to dye the swelled PVA-based resin film with the dyeing solution.
(3) A boric-acid treatment (cross-linking treatment) step of passing the dyed PVA-based resin film through a boric acid bath of an aqueous solution containing boric acid, causing cross-linking.
(4) A stretching step of stretching the PVA-based resin film.
(5) A water-washing treatment step of passing the boric acid-treated PVA-based resin film which is already transformed into a polarizer through a water-washing bath to wash the film with a liquid consisting primarily of water.
(6) A droplet removal step of scraping off droplets adhering to the polarizer by the droplet removal apparatus.
(7) A drying step of, after the water-washing treatment, passing the polarizer through a drying chamber.

Each of the steps other than the droplet removal step will be briefly described step-by-step below. The droplet removal step will be described in detail later.

### [Swelling Treatment Step]

First of all, a PVA-based resin film is subjected to a swelling treatment in the swelling bath 13. The swelling treatment is performed for the purpose of: removal of foreign substances on a surface of a film; removal of a plasticizer contained in the film; impartation of dyeability in a subsequent step; and plasticization of the film.

A swelling liquid for use in the swelling bath 13 may be pure water, or an aqueous solution to which boric acid, an inorganic salt typified by chloride, a water-soluble organic solvent typified by alcohol, or the like, is added. However, pure water containing substantially no dissolved component is preferably used for the swelling bath 13. This treatment makes it possible to wash off contamination or an antiblocking agent on a surface of a PVA-based resin film, and swell the PVA-based resin film to prevent ununiformity such as color unevenness. Glycerin, potassium iodide or the like is appropriately added to the swelling liquid.

### [Dyeing Treatment Step]

The PVA-based resin film which has undergone the above swelling treatment step involving stretching is passed through the dyeing bath 14 of a dyeing solution containing a dichroic dye, so that it is subjected to a dyeing treatment. Generally, as the dichroic dye, iodine or dichroic organic dye is used. The dyeing treatment is performed for the purpose of adsorbing a dichroic dye to the PVA-based resin film in an oriented state, and conditions therefor are determined to achieve such a purpose, without causing disadvantages such as extreme solution or less of transparency of the film.

### [Boric Acid Treatment (Cross-Linking Treatment) Step]

The PVA-based resin film which has undergone the dyeing treatment is subjected to a boric-acid treatment in the boric acid bath 15. The boric acid treatment is performed by immersing the PVA-based resin film dyed with the dichroic dye, in an aqueous boric acid solution in the boric acid bath.

### [Stretching Step]

In a stretching step, the dyed PVA-based resin film is stretched to attain a total stretching ratio of 5 to 6 times, while being immersed in an aqueous boric acid solution heated to about 60° C. In a commonly-used polarizer production method, stretching to a PVA-based resin film may be performed during at least one of the dyeing treatment step and the boric acid treatment step, and further during the swelling treatment step.

The stretching during one or two of the swelling treatment step, the dyeing treatment step and the boric acid treatment step is performed in a state in which the PVA-based resin film is swelled in each treatment bath, i.e., in a wet process. In embodiments of the present invention, stretching is basically performed during at least one of the dyeing treatment step and the boric acid treatment step, and during the swelling treatment step, as mentioned above. Therefore, the stretching is entirely performed in a wet process. Generally, such wet stretching is performed by passing the PVA-based resin film between a pair of rolls rotated at different circumferential velocities.

### [Water-Washing Treatment Step]

Generally, after the boric acid treatment step, the PVA-based resin film which is already transformed into a polarizer is subjected to a water-washing treatment in the water-washing bath 16. The water-washing treatment can be performed, for example, by immersing the boric acid-treated PVA-based resin film or the polarizer in water; spraying water to the film in a shower-like manner; or a combination of the immersion and the spraying. The water-washing treatment makes it possible to wash off an unwanted residue on the PVA-based resin film.

### [Drying Step]

Generally, the PVA-based resin film which has undergone the water-washing treatment is guided to the drying chamber 18 and subjected to drying. As the drying, any suitable technique (e.g., drying by air-blowing, or drying by heating) may be employed.

As above, through the swelling treatment step, the dyeing treatment step, the boric acid treatment step, the stretching step, the water-washing treatment step, the droplet removal step and the drying step, a finished polarizer 19 is obtained.

It should be noted that the order of the steps of swelling, dyeing, cross-linking, stretching, water-washing and drying, and the number of times and the presence or absence of implementation of each step, can be appropriately selected or determined depending on an intended purpose, an employed material, use conditions and others. For example, several treatments/operations may be simultaneously performed in one step. Specifically, the swelling treatment, the dyeing treatment and the cross-linking treatment may be simultaneously performed. Further, for example, a technique of performing the cross-linking treatment before and after the stretching may be preferably employed. Further, for example, the water-washing treatment may be performed after completion of all of the treatments and operations, or may be performed only after completion of a specific one of the treatments and operations.

The droplet removal apparatus 17 for use in the droplet removal step will be described in detail below.

### <Arrangement of Droplet-Removal Apparatus>

As illustrated in FIGS. 3(b) and 3(c), in the process using the droplet removal apparatus 17 according to one embodiment of the present invention, a droplet removal step is provided between the water-washing treatment step in the final bath 16 and the drying step in the drying chamber 18, to remove liquid droplets adhering to the surface of the PVA-based resin film pulled out from the final-stage bath so as to prevent the occurrence of water marks and/or foreign substances composed of vaporization residue on the polarizer. That is, the droplet removal apparatus 17 is installed between the final bath 16 and the drying chamber 18. In this case, the droplet removal apparatus 17 may be installed just above the final bath 16, as illustrated in FIG. 3(b), or may be installed offset from the final bath 16 on a downstream side, as illustrated in FIG. 3(c). Although FIG. 3 illustrates as an example the case where the droplet removal apparatus 17 is installed at a position just above the final bath 16, or at a position offset from the final bath 16 on the downstream side, the present invention is not limited thereto, but the droplet removal apparatus 17 may be installed at each of the two positions just above the final bath 16 and offset from the final bath 16 on the downstream side.

In the case where the droplet removal apparatus 17 is installed just above the final bath 16, as illustrated in FIG. 3(b), droplets scraped off from the PVA-based resin film fall into the final bath 16. On the other hand, in the case where the droplet removal apparatus 17 is installed at a position between the final bath 16 and the drying chamber 18 and offset from the final bath 16, as illustrated in FIG. 3(c), droplets scraped off from the PVA-based resin film is collected by a vessel (not shown) disposed beneath the droplet removal apparatus or the like.

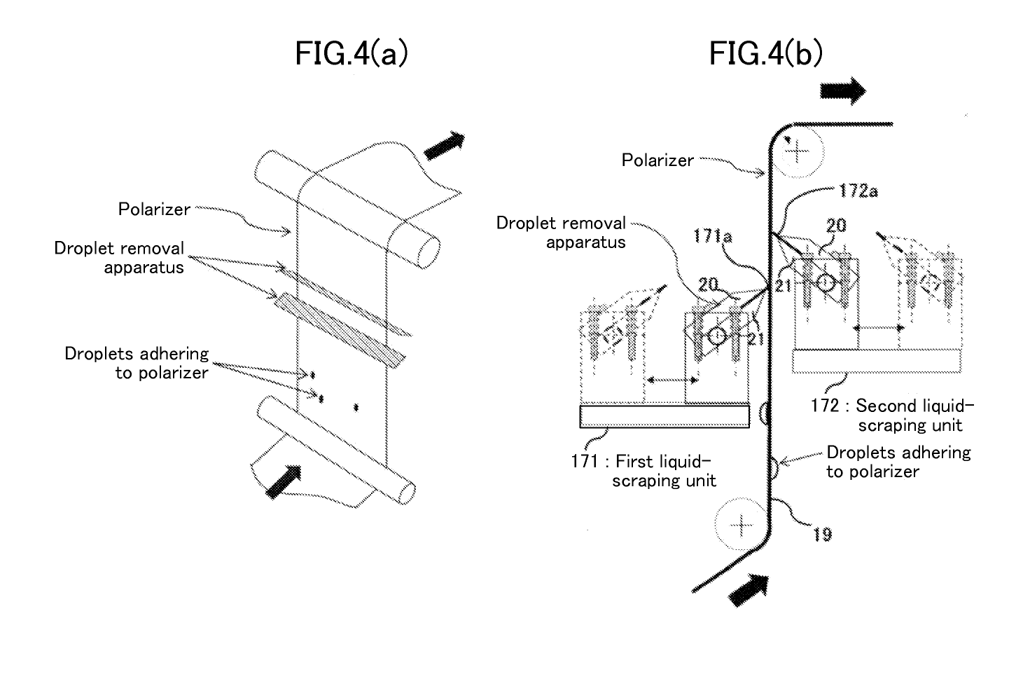

More specifically, as illustrated in FIG. 4(b), the droplet removal apparatus 17 comprises a first liquid-scraping unit 171 and a second liquid-scraping unit 172 which are arranged, respectively, on opposite sides, across a polarizer 19 as one example of an optical film, i.e., with respect to a movement direction of the polarizer 19, in opposed relation to each other in a chevron-like pattern. With a view to allowing respective conditions of opposite surfaces of the polarizer 19 to become close to the same, it is preferable to uniform the first liquid-scraping unit 171 and the second liquid-scraping unit 172 in terms of structure and shape. Further, as illustrated in FIG. 4(b), the first liquid-scraping unit 171 and the second liquid-scraping unit 172 are preferably displaced from each other, i.e., arranged in offset relation to each other, in an up-down relation along the movement direction of the polarizer 19 indicated by the black arrows in FIG. 4(b). Further, it is preferable that the first liquid-scraping unit 171 and the second liquid-scraping unit 172 are moved with respect to the polarizer 19 in a non-synchronous manner. An offset distance (displacement) between the first liquid-scraping unit 171 and the second liquid-scraping unit 172 in the up-down direction, i.e., an offset direction between a liquid-scraping blade 171a of the first liquid-scraping unit 171 and a liquid-scraping blade 172a of the second liquid-scraping unit 172 in the up-down direction along the movement direction of the polarizer (each of the liquid-scraping blades will hereinafter be abbreviated as “blade”) is preferably 20 mm or more, more preferably, 20 to 30 mm. Such offset arrangement makes it possible to adequately remove droplets while preventing damage to the polarizer.

### <Structures of First and Second Liquid-Scraping Units>

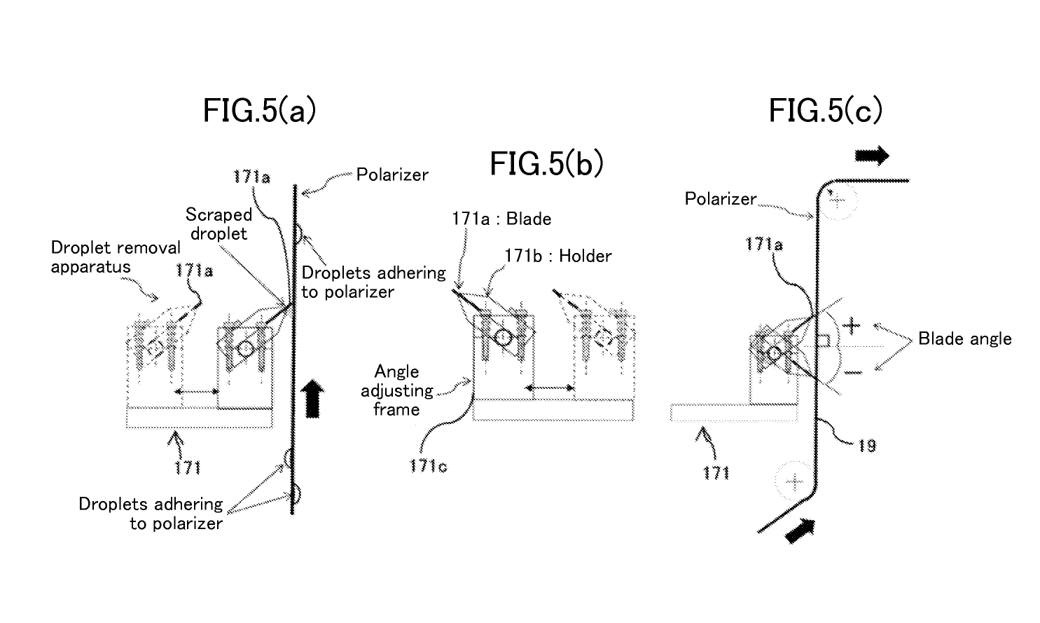

With reference to FIG. 5, regarding the first liquid-scraping unit 171 and the second liquid-scraping unit 172, the first liquid-scraping unit 171 will be described as a representative thereof. The first liquid-scraping unit 171 comprises: the blade 171a for scraping off droplets adhering to the polarizer 19; a holder 171b for holding the blade 171a; and an angle adjusting frame 171c for adjusting an angle of the holder 171b holding the blade 171a, with respect to the polarizer 19, i.e., an angle of the blade 171a with respect to the polarizer 19, so-called “blade angle”. The first liquid-scraping unit 171 may further comprises: a guide rail for allowing the angle adjusting frame 171c to be moved therealong, and a movement mechanism for moving the angle adjusting frame in forward and backward directions, as described later.

### [Blade (One Example of Liquid-Scraping Member)]

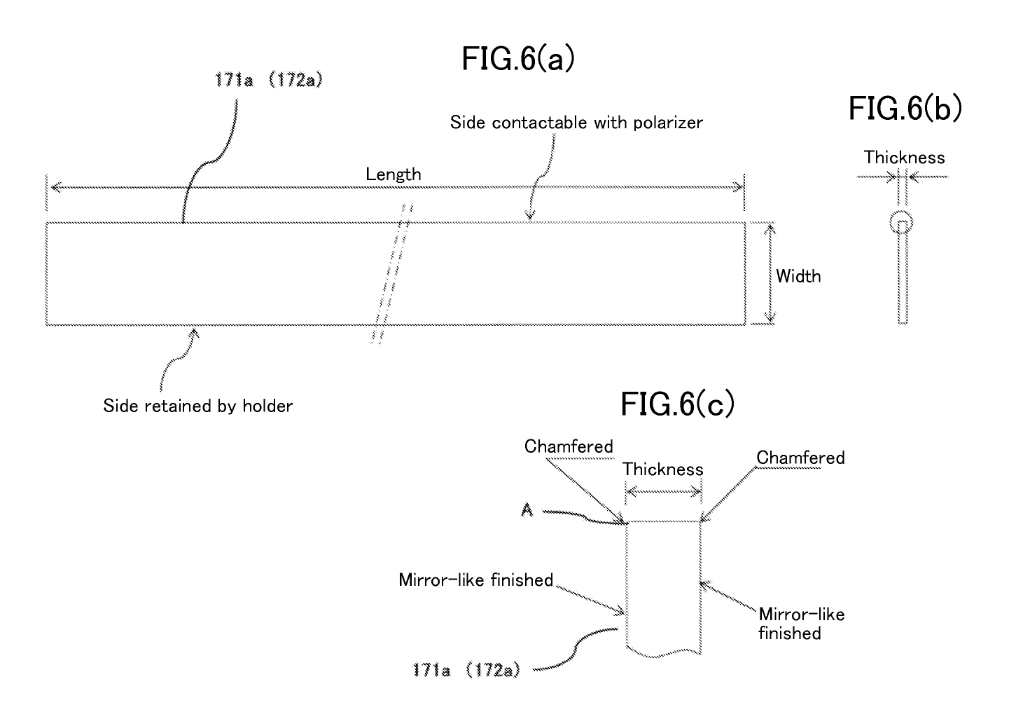

The blade 171a (172a) is a plate-shaped member configured to be pressed against the polarizer 19 in such a manner as to allow a distal side thereof to become parallel to a width direction of the polarizer 19, to thereby scrape off droplets adhering to the polarizer. The structure thereof is illustrated in FIG. 6. Examples of a material therefor include, but are not particularly limited to, abrasion-resistant stainless steel (e.g., SUS304), abrasion-resistant coated iron, abrasion-resistant resin materials, and abrasion-resistant ceramic materials. A length of the blade 171a (172a) depends on a width of the polarizer 19, and is generally set in the range of 1000 to 2500 mm. Preferably, with a view to suppressing abrasion in a region of the polarizer 19 coming in contact with corner edges of the blade 171a (172a), the blade 171a (172a) is formed to have a length slightly greater than the width of the polarizer, and corners of one side of the blade 171a (172a) to be brought into contact with the polarizer 19 is subjected to rounding or chamfering (see “A” in FIG. 6(c)). A thickness of the blade 171a (172a) is preferably 1 to 10 mm, more preferably, 3 mm. A width of the blade 171a (172a) between a side contactable with the polarizer and a side held by the holder is preferably 60 mm. Preferably, opposite surfaces of the blade are subjected to mirror-like finishing so as to prevent scraped droplet from adhering to the surfaces.

As long as the blade 171a (172a) can efficiently scraped off droplets adhering to the polarizer 19, a shape, size, material and others thereof are not limited to the above.

### [Holder (One Example of Liquid-Scraping Member Holding Mechanism)]

The holder 171b (172b) comprises a pressing-side holder member 20 and a support-side holder member 21 each having an approximately symmetric structure. One of the pressing-side holder member 20 and the support-side holder member 21 is formed with a blade-receiving space 22 so as to allow the blade 171a (172a) to be held therein. The pressing-side holder member 20 and the support-side holder member 21 are configured to be detachably fastened together by a blade retaining bolt 23 as one example of a first locking device. This is convenient for replacement of the blade 171a (172a).

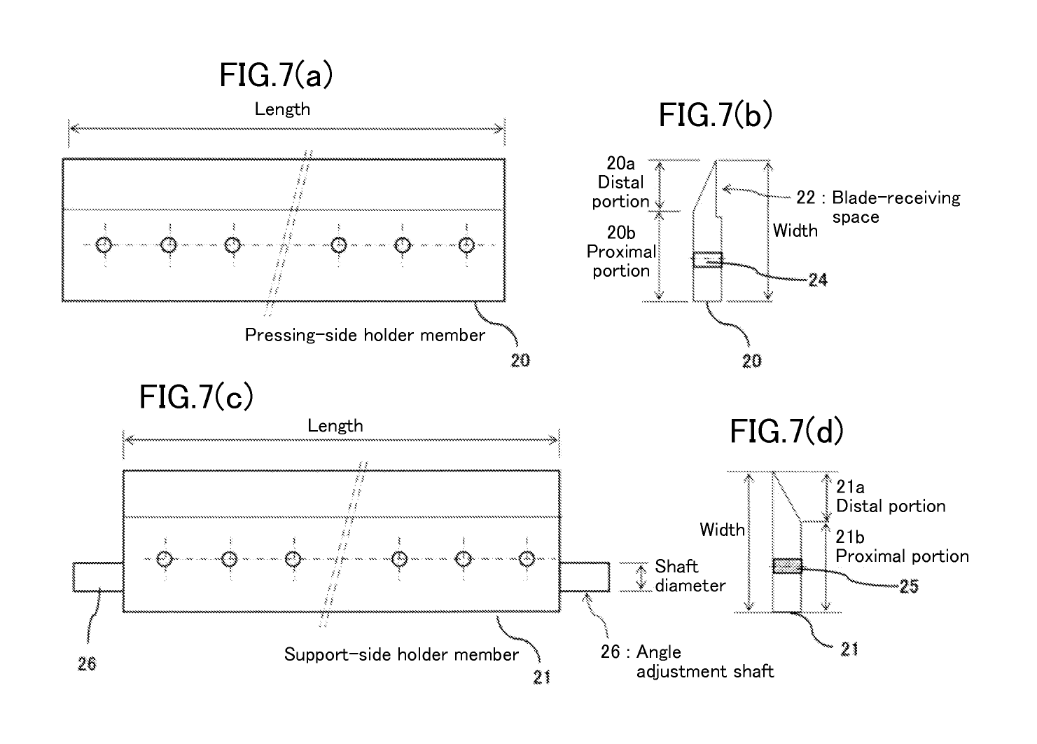

The holder members 20, 21 will be described in more detail. As illustrated in FIG. 7, each of the pressing-side and the support-side holder members 20, 21 has a length approximately equal to the length of the blade 171a (172a), and, in a cross-section when viewed inwardly from one lateral surface (when viewed leftwardly from a right lateral surface in FIG. 7) of the holder, comprises a distal portion (20a, 21a) for holding the blade 171a (172a), and a proximal portion (20b, 21b) formed with a hole (24, 25) for allowing the blade retaining bolt 23, i.e., the first locking device, for fastening the pressing-side holder member 20 to the support-side holder member 21, to be penetratingly inserted thereinto. In the cross-section, each of the proximal portions 20b, 21b has a width equal to about ⅔ of the overall width of the holder member, and is formed into a rectangular shape in which the hole (24, 25) is formed in an approximately central region in a width direction of the holder member. In the cross-section, each of the distal portions 20a, 21a has a width equal to about ⅓ of the overall width, and is formed continuously with the proximal portion (20b, 21b) to have a triangular shape in which a thickness thereof gradually decreases toward the side of the polarizer 19 (see FIGS. 7(b) and 7(c)).

As illustrated in FIG. 7(b), in the pressing-side holder member 20, a contact surface of the distal portion 20a with the blade is formed as a recess depressed leftwardly (in FIG. 7) with respect to an interface between the pressing-side holder member 20 and the support-side holder member 21 in such a manner as allow the blade to be received therein to thereby serve as the blade-receiving space 22. A depth of the recess may be set to be slightly less than the thickness of the blade. This is advantageous to retention of the blade. It should be noted that a location of formation of the blade-receiving space 22 is not limited to the pressing-side holder member 20. For example, the blade-receiving space 22 may be formed in the support-side holder member 21 or may be formed in each of the pressing-side holder member 20 and the support-side holder member 21. In any of these cases, it is preferable that the depth of the blade-receiving space 22 in a thickness direction of the blade is slightly less than the thickness of the blade. In the case where the depth of the blade-receiving space 22 is equal to or greater than the thickness of the blade, a spacer or the like may be employed so as to tightly fasten the blade.

Further, a plurality of the holes (24, 25) are formed over the entire length of the proximal portion (20b, 21b) of the pressing-side and support-side holder members 20, 21 at given intervals. As regards these holes, the number thereof is not particularly limited. The number may be set to any value which is enough to allow the blade to be tightly held, and convenient to an operation for replacing the blade.

The support-side holder member 21 has a pair of angle-adjusting holder shafts 26 (i.e., angle adjustment shaft) symmetrically formed, respectively, on opposite lateral surfaces of the proximal portion 21b, i.e., on longitudinally opposite edge faces of the support-side holder member 21, to protrude outwardly along a direction away from a longitudinal center of the holder member 21. The holder shafts 26 may be formed integrally with the holder member 21, or may be formed as a separate body and then assembled to the holder member 21 by means of welding, or thread engagement between internal and external threads, and a structure thereof is not particularly limited. Dimensions of each of the holder shaft 26 are not particularly limited as long as a shaft diameter thereof has strength capable of supporting the holder 20, and a length thereof is capable of being locked.

With a view to ensuring a pressing force against the polarizer 19, the blade 171a (172a) is held in a protruded state by the holder members 20, 21. However, the present invention is not limited thereto but the held state may be determined depending on a material, strength and thickness of the blade, liquid repellent property of the polarizer or the like.

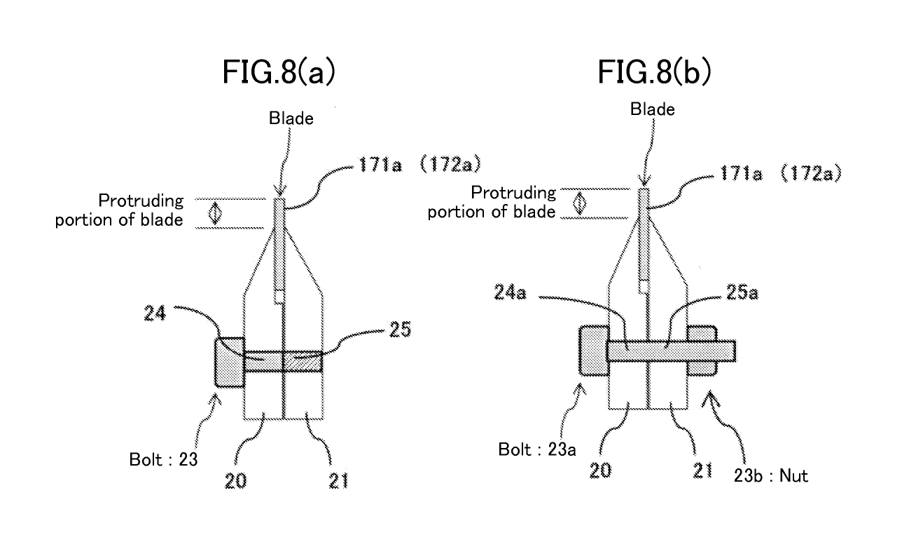

With reference to FIGS. 8(a) and 8(b), fastening of the pressing-side and support-side holder members 20, 21 by the blade retaining bolt 23 will be described below.

As illustrated in FIG. 8(a), as regards the holes 24, 25 formed, respectively, in the pressing-side and support-side holder members 20, 21, only each of the holes 25 of the support-side holder member 21 is formed as a threaded hole, and no thread is formed in each of the holes of the pressing-side holder member 20. In this case, after clamping the blade 171a (172a) between the pressing-side and support-side holder members 20, 21, the blade retaining bolt 23 is penetratingly inserted into the hole 24 of the pressing-side holder member 20, and then turned and threadingly engaged with the threaded hole 25 of the support-side holder member 21, thereby completing retention of the blade 171a (172a).

As another fastening scheme, in the example illustrated in FIG. 8(b), no thread is formed in any of holes 24a, 25a of the pressing-side and support-side holder members 20, 21, and the blade 171a (172a) is retained by using as a second locking device a nut 23a threadingly engaged with a blade retaining bolt 23a.

### [Angle Adjusting Frame (One Example of Angle Adjustment Mechanism)]

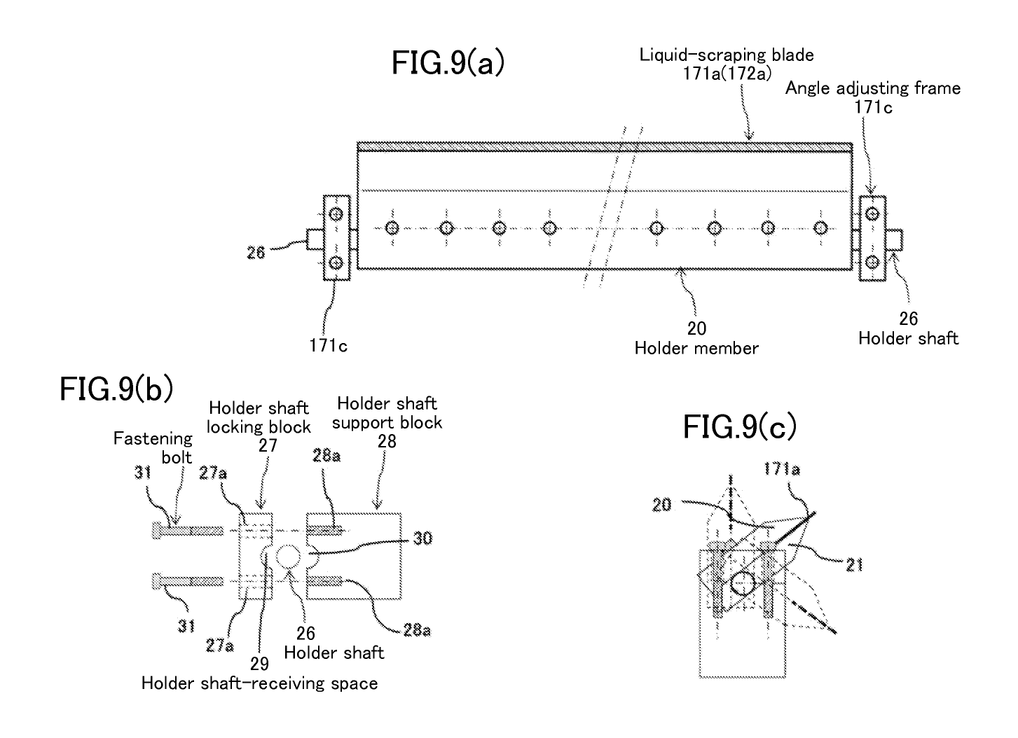

As illustrated in FIG. 9, the pair of angle adjusting frames 171c are designed to support the holder shafts 26 protrudingly formed, respectively, on the opposite lateral surfaces of the holder member 21 and adjust an angle of the blade 171a (172a), and provided, respectively, on longitudinally opposite sides (right and left sides) of the holder member 21, correspondingly to the right and left holder shafts 26. Each of the pair of angle adjusting frames 171c has the same structure. Thus, only one of the angle adjusting frames will be described below.

As illustrated in FIG. 9(a), the angle adjusting frame 171c comprises a locking block for holding the holder shaft 26, i.e., a holder shaft locking block 27, and a support block for supporting the locking block 27, i.e., a holder shaft support block 28, wherein two recesses 29, 30 are formed in respective central regions of opposed surfaces of the locking block 27 and the support block 28, as depressed portions conforming to an outer peripheral surface of the holder shaft 26 to allow the holder shaft 26 to be received therein, and a holder shaft-receiving space is defined by the recesses 29, 30. With a view to tightly locking the holder shaft 26, a height dimension of the holder shaft-receiving space in an up-down direction in a state in which the locking block 27 and the support block 28 are in contact with (mated to) each other without installing the holder shaft 26 is set to be slightly less than the diameter of the holder shaft 26. In the case where the height dimension of the holder shaft-receiving space is equal to or greater than the diameter of the holder shaft, a bush, a washer or the like may be employed so as to tightly lock the holder shaft.

Each of the support block 28 and the locking block 27 has a pair of holes formed, at respective positions across the holder shaft 26, i.e., on vertically opposite sides of the recess as seen in FIG. 9(b), and each configured to allow a fastening bolt 31 composing a third locking device to be threadingly engaged therewith. More specifically, the support block 28 is formed with a pair of threaded holes 28a, and the locking block 27 is formed with a pair of non-threaded through-holes 27a. In this case, after the holder shaft 26 is fitted into the recess 30 of the support block 28, the recess 29 of the locking block 27 and the recess 30 of the support block 28 are coupled together in such a manner as to interpose the holder shaft 26 therebetween. Then, each of the two fastening bolts 31 is penetratingly inserted into a corresponding one of the through-holes 27a of the locking block and turned and threadingly engaged with a corresponding one of the threaded holes 28a, whereby the holder shaft 26 is installed non-rotatably but detachably.

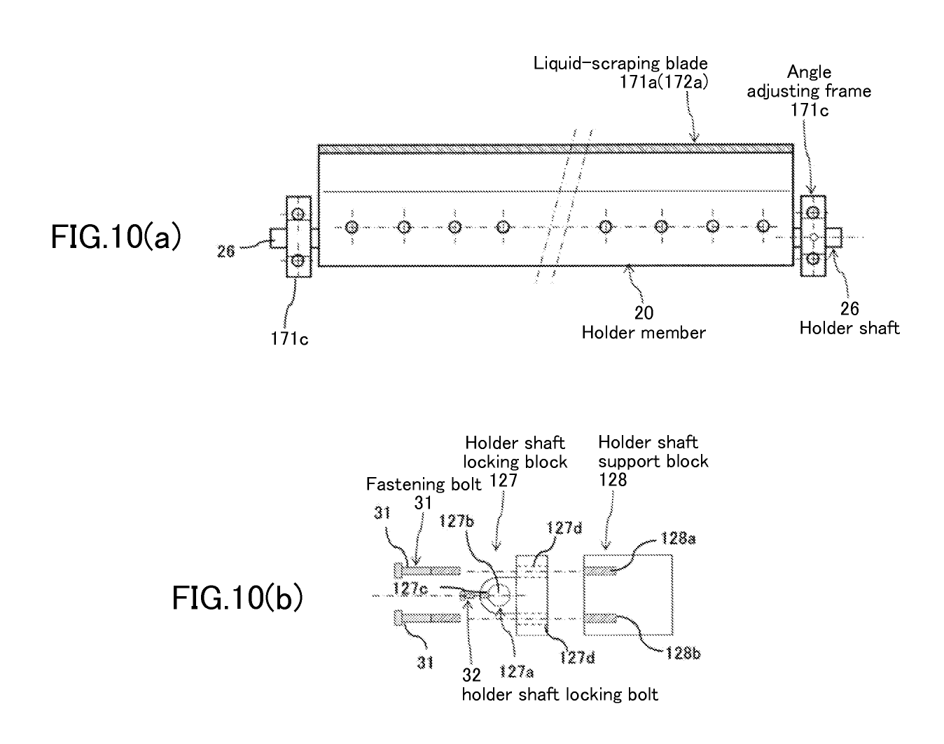

By modifying the structure illustrated in FIG. 9, the angle adjusting frame 171c may be constructed as illustrated in FIG. 10. Specifically, instead of forming in the respective opposed surfaces of the locking block 27 and the support block 28 the recesses for receiving therein the holder shaft 26, an upwardly-protruding, approximately semicircular-shaped boss 127a is formed on an upper surface of the locking block 27, i.e., a left surface of the locking block 27 in FIG. 10(b) as a surface thereof on a side opposite to a contact surface thereof with the support block, and a shaft hole 127b equivalent to the holder shaft-receiving space is formed in a central region of the boss 127a. In this case, a thickness of the boss 127a in a direction perpendicular to the width direction of the holder member 21 may be set to be equal to a thickness of the holder member 21 or may be set to be less than the thickness of the holder member 21. In either case, the boss is not particularly limited in terms of structure, as long as it allows the holder shaft to be tightly locked. The shaft hole 127b may have any size enough to allow the holder shaft 26 to be penetratingly inserted thereinto. In order to lock the holder shaft 26, the boss 127a is formed at the center of the circle defined by the perimeter thereof and at the center in the thickness-wise direction with a threaded hole 127c which extends along a longitudinal direction, that is a direction from left to right as seen in FIG. 10(b), of the holder, and configured to allow a holder shaft locking bolt 32 composing a fourth locking device to be threadingly inserted thereinto.

In this case, a pair of threaded holes 128a are formed in the support block 128 in the same manner as the threaded holes in FIG. 9(c), and a pair of through-holes 127d are formed in the locking block 127 at respective positions across the boss 127a.

It should be noted that, although the aforementioned structure comprises the locking block and the support block formed as separate parts, they may be integrally formed as a locking block functioning as the two blocks. In this case, it is possible to eliminate the need for the locking bolts for fastening the locking block to the support block, and the need for the locking bolt insertion non-threaded and threaded holes.

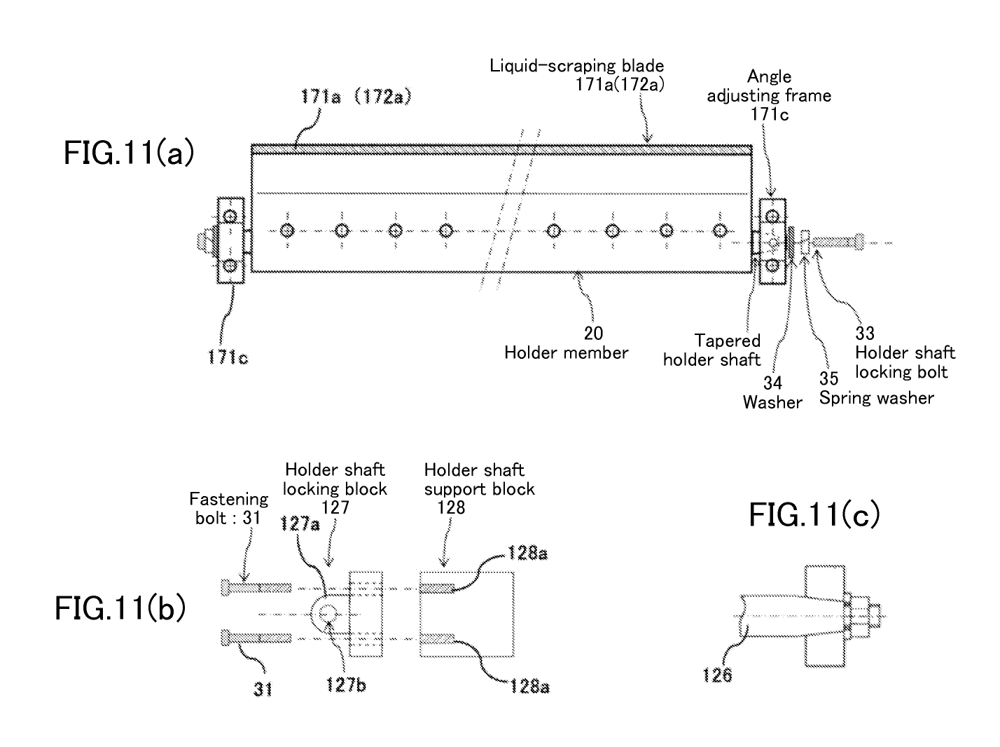

By further modifying the structure illustrated in FIG. 10, the angle adjusting frame 171c may be constructed as illustrated in FIG. 11 (b). In the structure illustrated in FIG. 11(b), the holder shaft and the boss in the structure illustrated in FIG. 10 are modified.

Specifically, as illustrated in FIG. 11(c), a holder shaft 126 is partially formed into a taper shape in which a shaft diameter thereof gradually decreases in a direction from a position spaced apart from a corresponding one of opposite lateral surfaces of the holder member 20 by a given distance toward the angle adjustment frame, and a threaded hole is formed in the taper-shaped portion of the holder shaft 126 along a central axis of the holder shaft 126, i.e., along a line indicated by the one-dot chain lines in FIGS. 11(a) and 11(c) and configured to allow a holder shaft locking bolt 33 composing a fourth locking device to be threadingly engaged therewith. The above “given distance” means a clearance necessary for installing the holder member to the angle adjusting frame 171c. In conformity to the taper-shaped portion of the holder shaft 126, the shaft hole 127b of the boss 127a is also formed into a taper shape to receive therein the taper-shaped portion. In this case, the threaded hole 127c illustrated in FIG. 10(b) is not formed in the outer peripheral wall of the boss 127a. Preferably, with a view to tightly locking the holder shaft 126, an axial length of the taper-shaped portion of the holder shaft is set to be less than a thickness of the boss 127a. In this structure, the holder shaft 126 can be locked by penetratingly inserting the holder shaft 126 into the shaft hole 127b, and then threadingly driving the holder shaft locking bolt 33 into the threaded hole of the holder shaft 126. In this locking scheme, it is desirable to employ a washer 34 and a spring washer 35.

An operation of adjusting an angle of the blade 171a (172a) is performed by: loosening the front and rear fastening bolts 31 in each of the right and left angle adjusting frames; then turning the blade 171a (172a) to a desired angle; and then tightening the fastening bolts 31 again to fix the angle of the blade 171a (172a). In this way, the angle of the blade 171a (172a) is initially adjusted in a standby state.

It should be noted that the angle adjusting frame 171c is not limited to the above hand-operated mechanism using the fastening bolts 31 or the holder shaft locking bolt 33, but may be configured to accurately perform the angle adjustment using a commercially available angular sensor.

The angle of the blade 171a (172a) is determined depending on a conveyance speed and liquid repellant property of the polarizer 19, and the angle of the blade 171a (172a) of the first liquid-scraping unit 171 (second liquid-scraping unit 172) is preliminarily adjusted and fixed. As illustrated in FIG. 5(c), in order to cope with various situations of droplets adhering to the polarizer 19, the angle θ of the blade 171a (172a) is adjusted within ±60° on the basis of a position at a right angle to the surface of the polarizer. While the right and left blades 171a, 172a may be set to the same blade angle, it is preferable that they are retained after being adjusted to respective different blade angles. For example, in side view, it is preferable that the angle of the right blade 171a is set to +60°, and the angle of the left blade 171b is set to +50°.

### EXAMPLES OF INSTALLATION OF DROPLET REMOVAL APPARATUS

### First Example

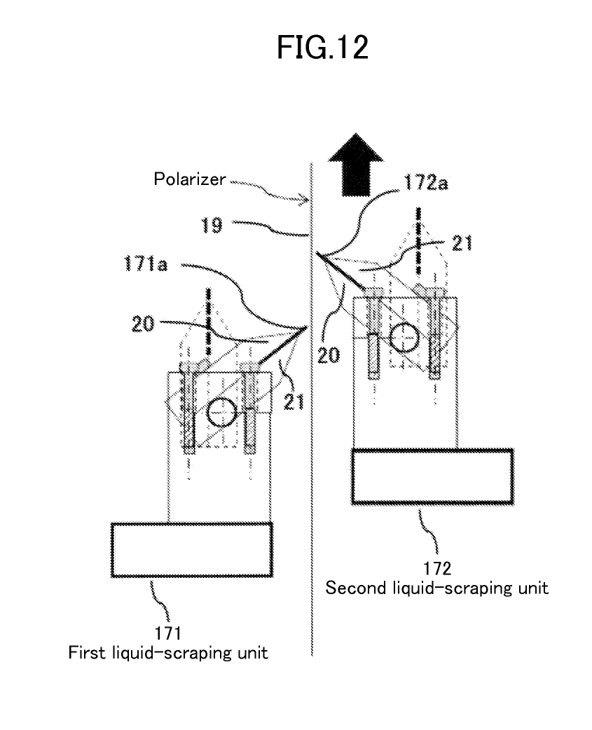

As illustrated in FIG. 12, in a first example of installation of the droplet removal apparatus 17, the first liquid-scraping unit 171 and the second liquid-scraping unit 172 are fixedly installed at respective positions on the opposite sides with respect to a vertical movement direction of the optical film 19, each of the units 171, 172 being positioned away from the optical film 19 by a given distance, i.e., a given first distance. This fixed installation structure is effective in a situation where an installation space of the droplet removal apparatus 17 is relatively narrow. In the structure of the first example, the droplet removal apparatus 17 is in a standby state wherein the angles of the holders 20, 21 are adjusted such that the blades 171a, 172a of the first liquid-scraping unit 171 and the second liquid-scraping unit 172 are directed in parallel to the movement direction of the polarizer 19. Then, in advance of start of the liquid-scraping step, the fastening bolts or the holder shaft locking bolt are loosened to rotate the holder shaft 26 and adjust the blade angle to a given value, and then tightened again.

In the first example, the holder 20 is capable of being disassembled, and configured to hold the blades 171a, 172a, so that it is convenient for replacement of a worn blade. In addition, the angle adjusting frame 171c is configured to allow the holder shaft 26 to be turned so as to adjust the angle of the blade 171a (172a) to a given angle. Thus, the droplet removal apparatus 17 according to the present invention can be universally used, irrespective of liquid repellant property of the polarizer 19, as long as the width thereof is equal to that of the polarizer 19.

### Second Example

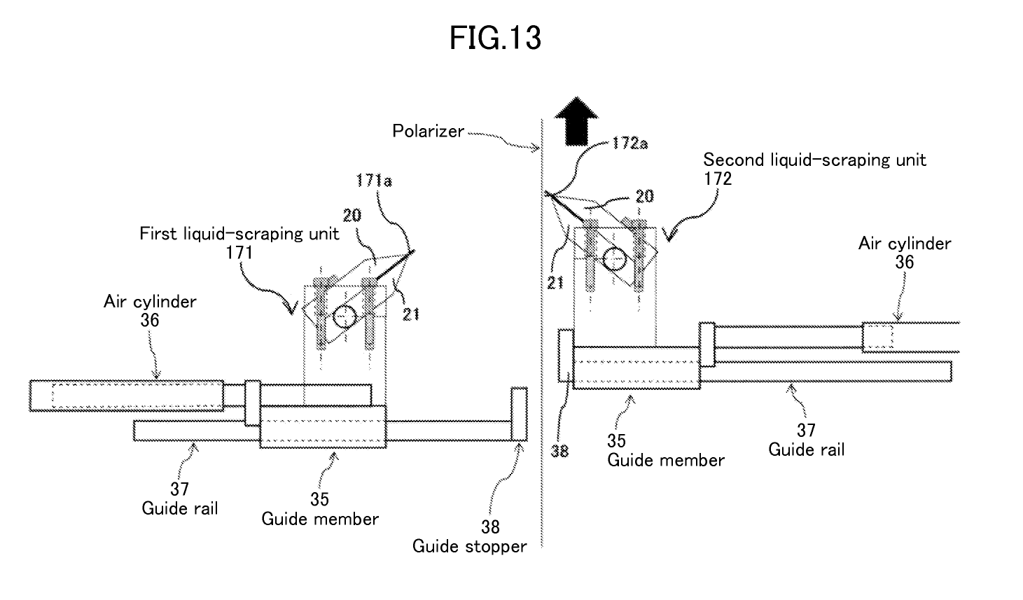

Differently from the first example where the droplet removal apparatus 17 is fixedly installed, as illustrated in FIG. 13, in the droplet removal apparatus 17 in a second embodiment, each of the first liquid-scraping unit 171 and the second liquid-scraping unit 172 comprises: a guide member 35 provided at a bottom of each of the angle adjusting frames 171c; an air cylinder 36 connected to the guide member 35; and a guide rail 37 configured to guide the guide member 35 in forward and backward directions, wherein the liquid-scraping unit can be moved in the forward and backward directions according to operation of the air cylinder 36 as a moving device, i.e., moved in the forward direction causing the liquid-scraping unit to come close to the polarizer 19, and in the backward direction causing the liquid-scraping unit to come away from the polarizer 19. In this case, the guide member 35 can come into contact with a guide stopper 38 provided at a distal end of the guide rail 37, i.e., an end of the guide rail 37 close to the polarizer 19, to stop the angle adjusting frame 171c on the guide rail 35 in response to sensing by a laser sensor or proximity sensor (not illustrated) provided on the angle adjusting frame 171c.

It should be noted that the guide stopper 38 may be provided adjustably in accordance with a depressed distance of the polarizer 19 by the blade 171a (172a), as described later, instead of being fixed to the guide rail 37.

Further, in place of the air cylinder 36, another type of moving device such as a ball screw may be provided, wherein the ball screw may be rotated by turning a handle, to thereby move the first liquid-scraping unit 17. It is to be understood that both of the air cylinder 36 and the set of a ball screw and a handle may be provided.

In this case, considering convenience to replacement of the blade 171a (172a), it is preferable that the first liquid-scraping unit 171 (second liquid-scraping unit 172) is kept in the standby state at a position away from the polarizer 19 by a given second distance, e.g., 100 mm or more, as indicated by the broken line in FIG. 4(b). It should be understood that the distance of the first liquid-scraping unit 171 (second liquid-scraping unit 172) in the standby state, from the polarizer 19, is not limited to 100 mm, but may be any other distance convenient to replacement of the blade 171a (172a).

In the second example, in addition to the advantageous effects in the first example, the first liquid-scraping unit 171 (second liquid-scraping unit 172) can be kept in the standby state at a position away from the polarizer 19 by a given distance, so that the replacement of the blade 171a (172a) becomes more convenient, and workability of maintenance of the first liquid-scraping unit 171 (second liquid-scraping unit 172) can be enhanced.

### Third Example

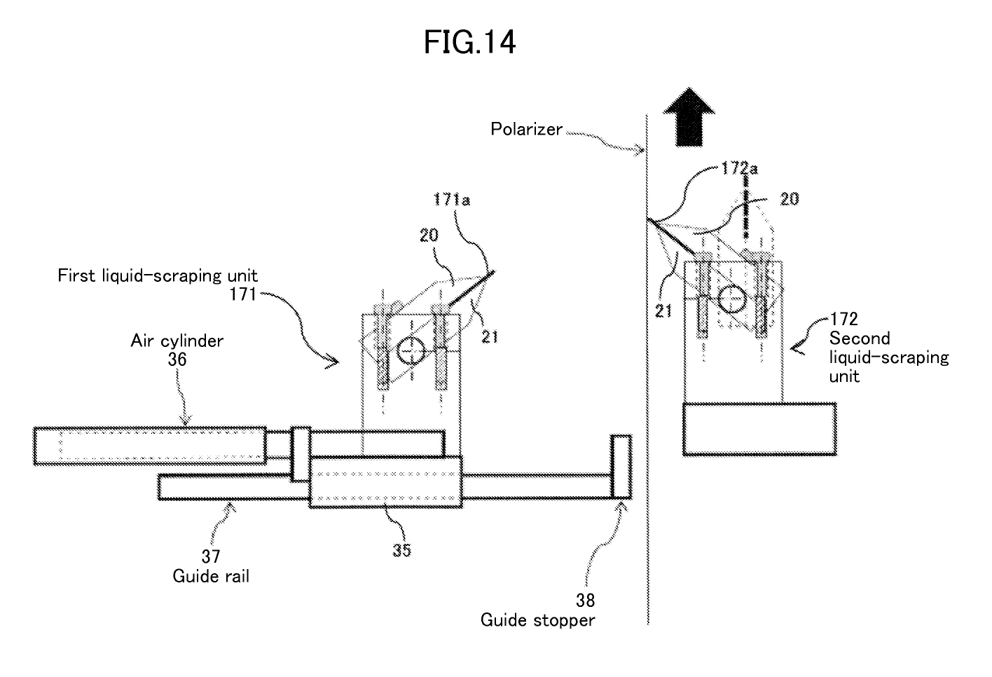

Differently from the first and second examples, in a third example, as illustrated in FIG. 14, one of the first liquid-scraping unit 171 and the second liquid-scraping unit 172 employs the structure in the first example, and the remaining one of the first liquid-scraping unit 171 and the second liquid-scraping unit 172 employs the structure in the second example.

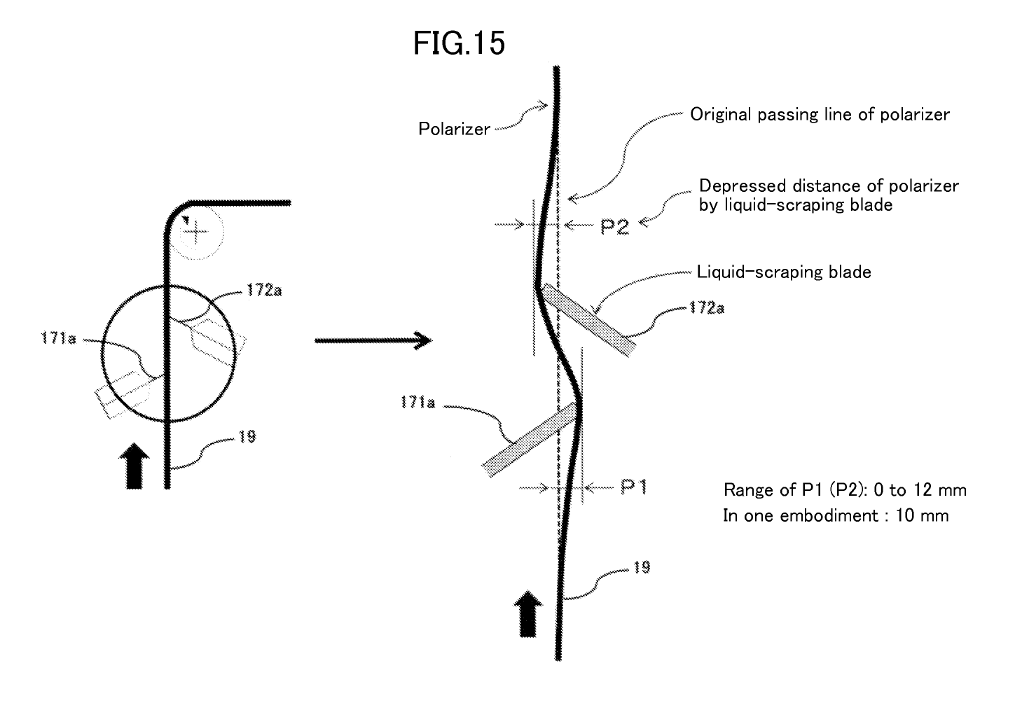

A pressing pressure of the blade 171a (172a) of the droplet removal apparatus 17 against the polarizer 19 is preliminarily set in view of liquid-scraping performance and damage to the polarizer. If a contact of the blade 171a (172a) against the polarizer 19 is excessively weak, a problem of deterioration in liquid-scraping performance occurs. On the other hand, if the contact is excessively strong, the polarizer 19 is damaged, and can be broken in the worst case. Thus, in order to allow the pressing pressure of the blade 171a (172a) against the polarizer 19 to become a setting value, a depressed distance P1 (P2) of the polarizer 19 illustrated in FIG. 15 is preferably set to 5 to 15 mm, more preferably, to 8 to 12 mm. The P1 (P2) means a distance between a passing line (indicated by the broken line) of a polarizer in a state in which the blade 171a (172a) is not in contact therewith, and a top of a curved portion of the polarizer formed by a pressing of the blade, as illustrated in FIG. 15. As long as the depressed distance falls within the above range, droplets can be scraped off without damaging the polarizer 19, so as to completely eliminate the risk of the occurrence of water marks and/or deposited impurities.

Although the droplet removal apparatus according to the present invention has been described, it is to be understood that the present invention is not limited to the above description, but various changes and modifications will be apparent to those skilled in the art. Therefore, unless otherwise such changes and modifications depart from the scope of the present invention hereinafter defined, they should be construed as being included therein.

For example, the present invention is applicable to a transparent protective film such as a TAC film, as well as application to a polarizer. Heretofore, an optical film such as a TAC film, or other transparent protective film, has been subjected to a saponification treatment comprising immersing the film into an aqueous alkaline solution, before bonding a polarizer thereto, in order to enhance adhesion between the polarizer and the transparent protective film. A transparent protective film continuously fed from a roll thereof by a drive roller is immersed in an alkali treatment bath, and, after being water-washed through a washing bath, wound on a roll via a drying oven, in the form of a saponified transparent protective film. In this case, the droplet removal apparatus according to the present invention may be installed between the washing bath and the drying oven.

### INDUSTRIAL APPLICABILITY

According to the present invention, it is possible to fully eliminate water marks and/or vaporization residues to ensure optical properties of an optical film, and therefore useful for removal of droplets on the optical film.

### LIST OF REFERENCE SIGNS

11: raw material film, 12: guide roller, 13: first bath, 14: second bath, 15: third bath, 16: fourth bath, 17: droplet removal apparatus, 18: drying chamber, 171: first liquid-scraping unit, 172: second liquid-scraping unit, 171a, 172a: blade

1. A droplet removal apparatus disposed between a final stage bath and a drying chamber in a production process of an optical film to remove droplets adhering to the optical film, said apparatus comprising:
a first liquid-scraping unit and a second liquid-scraping unit which are positioned at opposite sides with respect to a moving direction of an optical film, and capable of being displaced in a substantially vertical direction along the movement direction of the optical film;
wherein each of the first and second liquid-scraping units comprises:
a liquid-scraping member for scraping off the droplets and a liquid-scraping member holding mechanism;
said liquid-scraping member holding mechanism comprising a pressing-side holding member, and a support-side holding member, said support-side holding member having a pair of angle adjustment shafts provided, respectively, at longitudinally opposite ends thereof to protrude outwardly, the pressing-side holding member and the support-side holding member being detachably fastened together in such a manner as to cooperatively hold the liquid-scraping member; and
a pair of angle adjustment mechanisms provided, respectively, on longitudinally opposite sides of the liquid-scraping member holding mechanism, each of the angle adjustment mechanisms comprising a locking block formed with at least an angle adjustment shaft-receiving space for receiving therein a corresponding one of the angle adjustment shafts, each of the angle adjustment mechanisms being configured to adjust and lock the liquid-scraping member holding mechanism in such a manner as to allow an angle of the liquid-scraping member with respect to the optical film to be set to a given value.

2. The droplet removal apparatus as recited in claim 1, wherein the first and second liquid-scraping units are fixedly installed at respective positions across the optical film and each away from the optical film by a given first distance.

3. The droplet removal apparatus as recited in claim 1, wherein each of the first and second liquid-scraping units further comprises: a guide member provided at a bottom of each of the angle adjustment mechanisms; a moving device connected to the guide member; and a guide rail configured to guide the guide member in forward and backward directions and having a guide stopper at a distal end thereof, and wherein the first and second liquid-scraping units are movably installed at respective positions across the optical film and each away from the optical film by a given second distance.

4. The droplet removal apparatus as recited in claim 1, wherein one of the first and second liquid-scraping units is fixedly installed at a position on one of the opposite sides of the optical film and away from the optical film by a given first distance, and the remaining one of the first and second liquid-scraping units is movably installed at a position on the other side of the optical film and away from the optical film by a given second distance, and wherein the movable one of the first and second liquid-scraping units further comprises: a guide member provided at a bottom of each of the angle adjustment mechanisms; a moving device connected to the guide member; and a guide rail configured to guide the guide member in forward and backward directions and having a guide stopper at a distal end thereof.

5. The droplet removal apparatus as recited in claim 1, wherein
the pressing-side holding member is formed with a through-hole for allowing a first locking device for detachably fastening the pressing-side holding member and the support-side holding member together to be penetratingly inserted thereinto, and
the support-side holding member is formed with a threaded hole for receiving the first locking device for a thread engagement therewith to thereby establish the retention of the liquid-scraping member.

6. The droplet removal apparatus as recited in claim 1, wherein each of the pressing-side holding member and the support-side holding member is formed with a through-hole for allowing a first locking device for detachably fastening the pressing-side holding member and the support-side holding member together to be penetratingly inserted thereinto, and wherein the pressing-side holding member and the support-side holding member are fastened together by penetratingly inserting the first locking device into the respective through-holes thereof and fixing the first locking device by a second locking device.

7. The droplet removal apparatus as recited in claim 1, wherein each of the angle adjustment mechanisms further comprises a support block for supporting the locking block,
and wherein the angle adjustment shaft-receiving space is defined by two recesses formed in respective central regions of opposed surfaces of the locking block and the support block,
and wherein
the support block has a pair of threaded holes formed at respective positions across the recess thereof and each configured to allow a third locking device to be threadingly engaged therewith, and
the locking block has a pair of through-holes formed at respective positions across the recess thereof and each configured to allow the third locking device to be penetratingly inserted thereinto.

8. The droplet removal apparatus as recited in claim 1, wherein each of the angle adjustment mechanisms further comprises a support block for supporting the locking block,
wherein:
the locking block has an approximately semicircular-shaped boss formed on a surface thereof on a side opposite to a contact surface thereof with the support block to protrude in a direction away from the support block;
the angle adjustment shaft-receiving space is formed in a central region of the boss; and
the boss has a threaded hole formed at a center of an outer peripheral wall thereof in its circumferential and thickness directions to extend along a support direction of the support block and configured to allow a fourth locking device to be threadingly driven thereinto,
wherein
the locking block has a pair of through-holes formed at respective positions across the boss thereof and each configured to allow a third locking device to be penetratingly inserted thereinto, and
the support block has a pair of threaded holes formed correspondingly to the through-holes of the locking block.

9. The droplet removal apparatus as recited in claim 1, wherein each of the angle adjustment mechanisms further comprises a support block for supporting the locking block,
wherein
the locking block is provided at a side opposite to the side facing to said support block with an approximately semicircular-shaped boss to protrude in a direction away from the support block, and
the angle adjustment shaft-receiving space for receiving therein a corresponding one of the angle adjustment shafts is formed in a central region of the boss,
wherein:
each of the angle adjustment shafts is partially formed into a taper shape in which a shaft diameter thereof gradually decreases in a direction from a position spaced apart from a corresponding one of opposite lateral surfaces of the liquid-scraping member holding mechanism by a given distance toward a corresponding one of the angle adjustment mechanisms;
the angle adjustment shaft-receiving space is formed into a taper shape to receive therein the taper-shaped portion of the corresponding angle adjustment shaft; and
the angle adjustment shaft is formed along a longitudinal axis thereof a threaded hole for receiving a fourth locking device in a threading engagement therewith to thereby lock the angle adjustment shaft, wherein an axial length of the taper-shaped portion of the angle adjustment shaft is less than a thickness of the boss,
and wherein
the locking block has a pair of through-holes formed at respective positions across the boss thereof and each configured to allow a third locking device to be penetratingly inserted thereinto, and
the support block has a pair of threaded holes formed correspondingly to the through-holes of the locking block.

10. The droplet removal apparatus as recited in claim 1, wherein:
the locking block has an approximately semicircular-shaped boss protrudingly formed on an upper surface thereof;
the angle adjustment shaft-receiving space is formed in a central region of the boss; and
the boss has a threaded hole formed at a center of an outer peripheral wall thereof in its circumferential and thickness directions to extend in a direction along which the locking block stands and configured to allow a fourth locking device to be threadingly driven thereinto.

11. The droplet removal apparatus as recited in claim 1, wherein the locking block has an approximately semicircular-shaped boss protrudingly formed on an upper surface thereof, and the angle adjustment shaft-receiving space for receiving therein a corresponding one of the angle adjustment shafts is formed in a central region of the boss, and wherein:
each of the angle adjustment shafts is partially formed into a taper shape in which a shaft diameter thereof gradually decreases in a direction from a position spaced apart from a corresponding one of opposite lateral surfaces of the liquid-scraping member holding mechanism by a given distance toward a corresponding one of the angle adjustment mechanisms;
the angle adjustment shaft-receiving space is formed into a taper shape to receive therein the taper-shaped portion of the corresponding angle adjustment shaft; and
the angle adjustment shaft is formed along a longitudinal axis thereof with a threaded hole for receiving a fourth locking device in a threading engagement therewith to thereby lock the angle adjustment shaft, wherein an axial length of the taper-shaped portion of the angle adjustment shaft is less than a thickness of the boss.

12. The droplet removal apparatus as recited in claim 1, wherein an offset distance between the first and second liquid-scraping units in the up-down direction is 20 to 30 mm.

13. The droplet removal apparatus as recited in claim 1, wherein a depressed distance of the optical film by the liquid-scraping member is 5 to 15 mm.

14. The droplet removal apparatus as recited in claim 1, wherein the respective liquid-scraping members of the first and second liquid-scraping units are disposed in opposed relation to each other in such a manner that an angle of the liquid-scraping member of the first liquid-scraping unit with respect to the optical film becomes different from an angle of the liquid-scraping member of the second liquid-scraping unit with respect to the optical film.

15. The droplet removal apparatus as recited in claim 1, wherein the liquid-scraping member has a length greater than a width of the optical film.

16. The droplet removal apparatus as recited in claim 15, wherein corners of one side of the liquid-scraping member to be brought into contact with the optical film are subjected to rounding or chamfering.

17. The droplet removal apparatus as recited in claim 15, wherein opposite surfaces of the liquid-scraping member are subjected to mirror-like finishing.

18. The droplet removal apparatus as recited in claim 15, wherein the liquid-scraping member is formed of one or more selected from the group consisting of: abrasion-resistant stainless steel, abrasion-resistant coated iron, abrasion-resistant resin materials, and abrasion-resistant ceramic materials.

19. The droplet removal apparatus as recited in claim 15, wherein the liquid-scraping member has a thickness of 1 to 10 mm.

20. The droplet removal apparatus as recited in claim 1, wherein the pressing-side holding member and/or the support-side holding member of the liquid-scraping member holding mechanism are formed to define a liquid-scraping member-receiving space for holding the liquid-scraping member.

21. The droplet removal apparatus as recited in claim 3, wherein the moving device is composed of one selected from the group consisting of an air cylinder, a set of a ball screw and a handle, and a combination thereof.

22. The droplet removal apparatus as recited in claim 3, which comprises a laser sensor or a proximity sensor as a substitute for the guide stopper.

23. The droplet removal apparatus as recited in claim 3, wherein each of the angle adjustment mechanisms further comprises an angular sensor.
